(19) United States
(12) Patent Application Publication
(10) Pub. No.: US 2006/0080201 A1
(43) Pub. Date: Apr. 13, 2006

(54) Server/client system

(75) Inventor: Tadahiro Itou, Owariasahi (JP)

Correspondence Address: MCDERMOTT WILL & EMERY LLP, 600 13TH STREET, N.W., WASHINGTON, DC, 20005-3096, US

(73) Assignee: Hitachi-Omron Terminal Solutions, Corp.

(21) Appl. No.: 11/194,468

(22) Filed: Aug. 2, 2005

(30) Foreign Application Priority Data
Sep. 22, 2004 (JP) 2004-274340

(51) Int. Cl. G06Q 40/00

(52) U.S. Cl. 705/35

(57) ABSTRACT

A server/client system includes a plurality of terminals for inputting requests of transactions; a first server for communicating with a host on the basis of the request of the transaction inputted by the terminal; and a second server having a device control program for controlling devices on the basis of an instruction from the first server corresponding to the communication with the host.

### INCORPORATION BY REFERENCE

The present application claims priority from Japanese application JP2004-274340 filed on Sep. 22, 2004, the content of which is hereby incorporated by reference into this application.

### BACKGROUND OF THE INVENTION

This invention relates to a server/client system utilized in branches of a financial institution.

Teller terminals described in JP-A-5-204585 are installed in a branch of a financial institution. The teller terminals are installed at counters of the branch and have the function of controlling financial devices such as a cash dispenser and a bank book printer.

To decrease the scale of the terminal devices and to facilitate the increase/decrease of their number, JP-A-9-160894 describes a system in which a plurality of terminals each including a display, a printer, etc, is parallel controlled apparently simultaneously by a main control portion connected through a line.

### SUMMARY OF THE INVENTION

According to the technology described in JP-A-5-204585 described above, the financial devices such as the cash dispensers and the bank book printers must all be controlled by the terminal. Therefore, the cost is high for branch terminals (Fat client).

The technology described in JP-A-9-160894 described above can be utilized for general purpose devices such as simple displays, keyboards and printers. In the case of the financial devices such as the cash dispensers and the bank book printers, however, the quantity of communication information as the control object is large owing to the complicated operations of the financial devices, and the system construction disclosed in JP-A-160894 cannot cope with control of the financial devices.

The invention employs the following construction to solve the problems described above, for example.

A server/client system including a plurality of terminals for inputting requests of transactions, a first server for communicating with a host on the basis of the request of the transaction inputted by the terminal, and a second server having a device control program for controlling devices on the basis of an instruction from the first server corresponding to the communication with the host.

A server/client system including a Rich client having specific screen definition information, a Thin client not having the specific screen definition information and an application server having a function of adding the specific screen information and transmitting the information when an instruction is judged as the instruction for the Thin client by judging whether the instruction is for the Rich client or for the Thin client.

A branch system including a device control server having a device control program for controlling at least one of a cash dispenser for paying and receiving a cash and a bank book printer for conveying a bank printer and printing the bank printer, a Rich client having the device control function, a Thin client not having the device control function, and an application server for judging whether a client is the Rich client or the Thin client in a transaction utilizing at least one of the cash dispenser and the bank book printer, transmitting an instruction for a device in the transaction to the Rich client when the client is judged as the Rich client and transmitting the instruction for the device in the transaction to the Thin server when the client is judged as the Thin client.

The invention can improve freedom or cost-down of the branch system including complicated financial devices.

Other objects, features and advantages of the invention will become apparent from the following description of the embodiments of the invention taken in conjunction with the accompanying drawings.

### BRIEF DESCRIPTION OF THE DRAWINGS

FIG. 1 is a block view showing an example of a construction of a center and a branch;

FIG. 2 is a view showing an arrangement example of financial devices in the branch;

FIG. 3 is a block view showing an example of a construction of a server and a client;

FIG. 4 is a flowchart showing an example of a processing by an AP server;

FIG. 5A is a view showing a screen example 1 of a Thin client;

FIG. 5B is a view showing a screen example 2 of the Thin client; and

FIG. 6 is a flowchart showing a modified example of a processing by the AP server.

### DESCRIPTION OF THE EMBODIMENTS

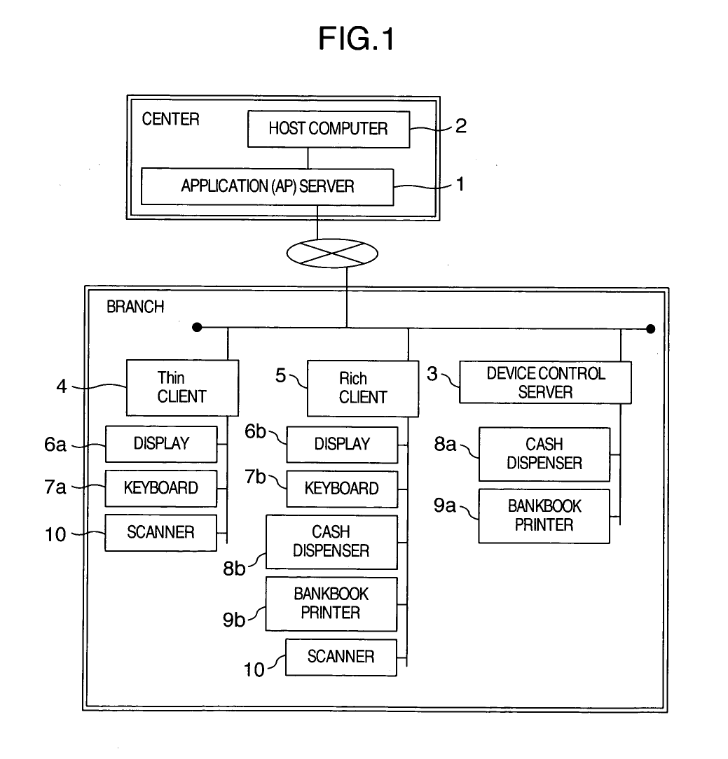

The form utilized by a financial institution will be explained by way of example. Incidentally, hardware construction, software construction and their functions to be explained with reference to FIGS. 1 to 6 are mere examples and the invention need not necessarily have all these constructions and functions but the operation and function can be improved when the invention does.

FIG. 1 is a block view showing the outline of the construction of each of the center and the branch of the financial institution.

The center includes a host computer 2 (host 2) and an application server 1 (AP server 1). The host 2 is a basic system of the financial institution and manages the increment/decrement of the deposit amount occurring in the account transactions such as deposit transactions, drawing transactions and transfer transactions, for example. The host 2 is generally constituted by a main frame but it may be constituted by a server, too. The AP server 1 will be described later.

The branch includes a plurality of Thin clients 4 and/or Rich clients 5 operated by tellers at counters of the branch, a display 6 for displaying an input screen for the teller by a liquid crystal display, for example, an input device (keyboard 7, mouse, touch panel, etc) for inputting data to the input screen of the display 6, a cash dispenser 8 for receiving the cash the teller receives from a client or withdrawing the cash to be paid to the client, a bankbook printer 9 for conveying a bankbook, printing amounts by a printing head and turning over pages in some cases, an image acquisition device (scanner, etc) 10 for acquiring an image of a slip such as a transfer slip or a deposit slip and a device control server 3. Preferably, the scanner is connected to the Thin client 4 and character recognition software for recognizing the image acquired by the scanner, too, is stored in and executed by the Thin client 4. For, a large load is applied to the network when data is transmitted to the AP server 1 for the character recognition processing because the capacity of the image data is great, and the processing on the client side becomes faster. For the same reason, the character recognition software is more desirably installed to the device control server 3 rather than to the AP serve 1.

The cash dispenser 8 has a shutter at its dispensing port and includes a roller belt motor for delivering the cash (bank notes), a judgment device for judging the kind of the bank notes and its authenticity, an accommodation box for accommodating the cash. The bankbook printer 9 includes a roller motor for conveying the bankbook, a magnetic reader/writer for reading and writing magnetic information from and to a magnetic stripe bonded to the bankbook, a scanner for optically reading printed rows of the bankbook, a printing head for printing data to the bankbook and a page turn-over roller for turning over the pages of the bankbook. Incidentally, the bankbook printer 9 has an upper inserter for inserting a slip at its upper portion and a lower inserter for inserting the bankbook at its lower portion so that the medium inserted can be conveyed and printed.

Those devices which are not used in ordinary business offices but are used particularly in financial institutions such as the cash dispenser 8 and the bankbook printer 9 are called “financial devices”. Ordinary laser printers and ink jet printers are not the financial devices. The financial device may further include an automated teller machine (different from the cash dispenser 8; so-called “ATM”) that is operated by a customer (end user) having an account, a reception terminal for receiving a client visiting to the branch and outputting a slip on which a reception number for guiding the client to the counter is printed, a lobby terminal for simulating a loan, for example, through the operation of the client, a ledger machine for managing the cash inside the branch separately from the cash dispenser installed in the branch terminal, a bankbook issuing machine (PIM) for issuing a bankbook, a credit issuing machine (BIM) for issuing a credit such as a check, a card issuing machine (ACM) for issuing a card by printing emboss characters to a card and a transfer ticket issuing machine for issuing a transfer ticket.

Whereas the financial devices are connected to the Rich client 5, they are not to the Thin client 4. For, the Rich client 5 has the function of controlling the financial devices but the Thin client 4 does not. However, the Thin client 4 can utilize the financial devices connected to the device control server 3. When the Thin client 4 and the Rich client 5 are used conjointly, the system operation that takes a cost and a utilization ratio into consideration can be introduced by using the Rich client as the client that ordinarily uses the financial devices and the Thin client as the client that uses the financial devices only when busy.

The Rich client 5 and the Thin client 4 are respectively called “first client” and “second client”, too. The branch terminals are altogether called “clients”, as well. The AP server 1 is called “flow control server” and “first server”, too. The device control server is called “second server”. The server and the host are generically called “host apparatuses”, too.

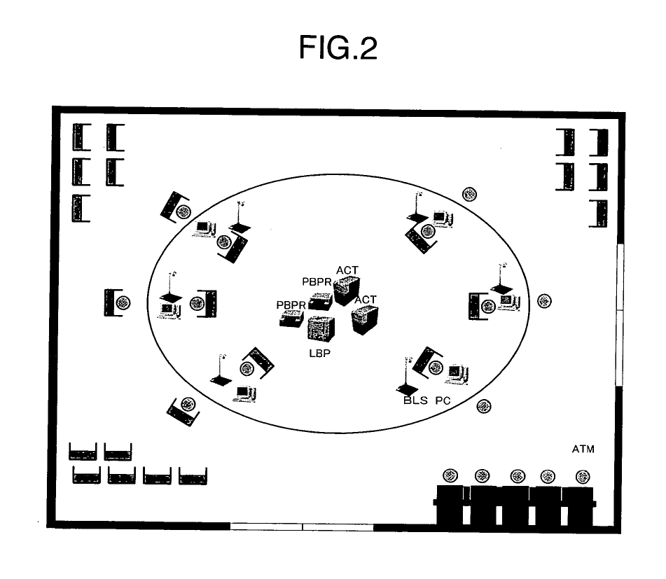

Lines connecting each construction preferably have a large capacity or in other words, a high communication speed. Generally, the capacity is the greatest in the lines connecting the client and the device control server 3 to the financial devices and next in the lines connecting the client and the device control server 3, followed by the lines connecting the branch and the center. From this relationship of the capacity of the lines, the device control server 3, the Rich client 5 and the financial devices may be connected in parallel though the financial devices are shown connected to the device control server 3 and the Rich client 5 in FIGS. 1 and 2.

FIG. 2 shows an example of layout of the hardware shown in FIG. 1 in the branch. The number of financial devices is optimized to reduce the cost. This layout can eliminate the existing concept of layout of the branch that sets up one row for dealing with the cash and two rows for rear service processing and can arrange a consultation counter for each transaction. The clients 4/5 (PC), the cash dispensers 8 (ACT), the bankbook printers 9 (PBPR), the laser printers (LBP), the scanners 10 (BLS) and the automatic teller machines are shown arranged by way of example.

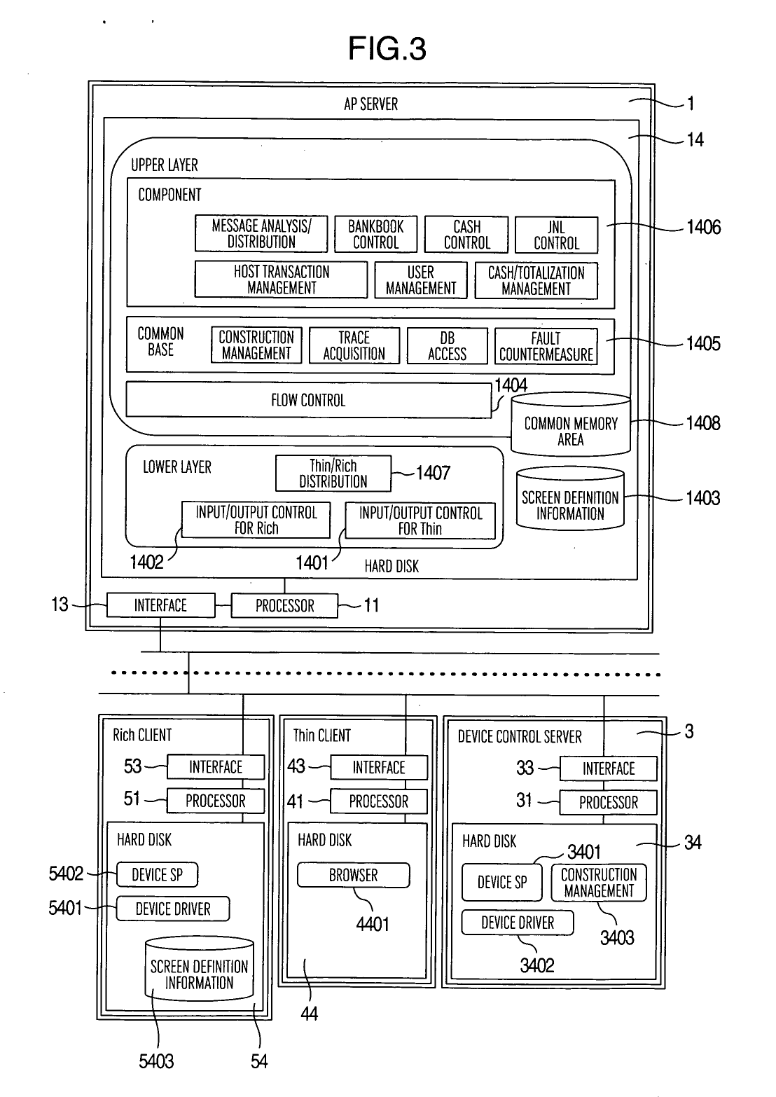

FIG. 3 shows a detailed block view of the AP server 1, the device control server 3, the Rich client 5 and the Thin client 4.

The AP server 1 includes, for example, a processor 11 containing an integrated circuit on a semiconductor and having semiconductor memories, a hard disk 14 for storing magnetic information into a magnetic disk, for example, and an interface 13 for transmitting messages when connected to the lines. The hard disk 14 stores various programs, data and files, and is called “storage portion” with the semiconductor memories. The term “execution of program” will hereinafter mean that the processor calls out and executes the program from the hard disk.

The AP server 1 has a lower layer for executing terminal input/output control for the Thin client 4 and terminal input/output control for the Rich client 5 and an upper layer including a flow controller 1404 for managing and controlling a processing sequence and a component group 1406 for executing the processing. The lower layer and the upper layer may respectively correspond to a transport layer and an application layer in a TCP/IP layer construction, for example, but both lower and upper layers may exist in the application layer.

The lower layer absorbs the difference of the kinds of the clients, that is, the difference between the Thin client 4 and the Rich client 5. Consequently, the upper layer can assume the construction and the processing that do not depend on the kind of the clients. However, the Thin client 4 and the Rich client 5 can be used conjointly when the difference is not absorbed by the lower layer alone but is absorbed integrally by the host apparatus and the lower layer.

To absorb the difference between the Thin client 4 and the Rich client 5, the lower layer of the AP server 1 has an input/output control program 1401 for Thin, for controlling transmission/reception to and from the Thin client 4, an input/output control program 1402 for Rich, for controlling transmission/reception to and from the Rich client 5 and a Thin/Rich distribution program 1407.

The Thin/Rich distribution program 1407 analyzes the message received from the upper layer, judges whether it is to be sent to the Thin client 4 or to the Rich client 5 and hands it over to the input/output control program 1401 for the Thin client when the message is for the former and to the input/output control program for the Rich client when the message is for the latter.

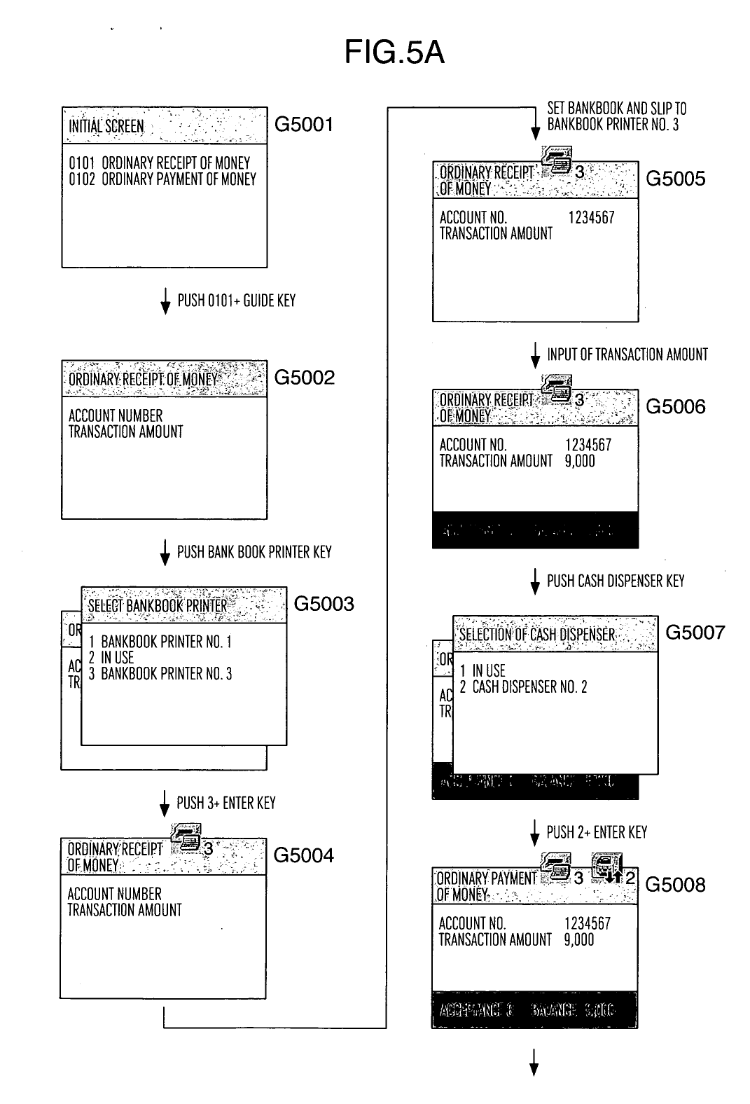

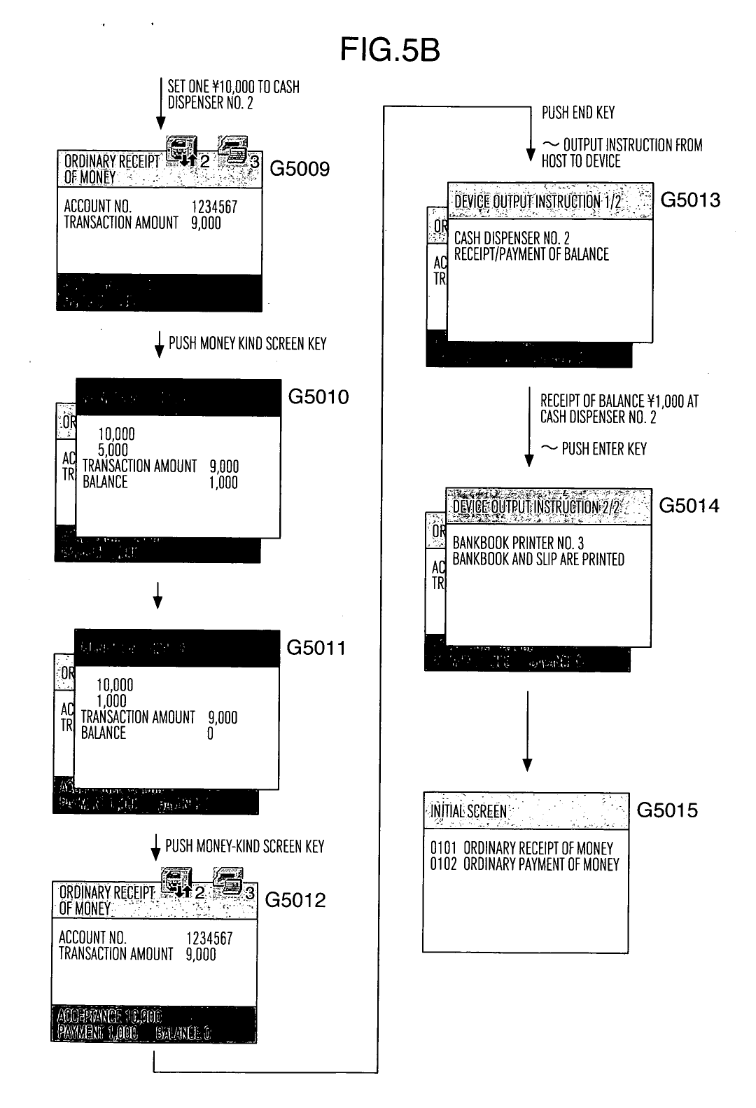

The input/output control program 1401 for Thin analyzes the input (transmission) data from the Thin client 4, accumulates the data, returns a next screen when the input screens are plural and asks subsequent input. When receiving the input data for the last input screen among the input screens for receiving a series of data inputs by an operator (teller) of the Thin client 4, the input/output control program 1401 for Thin transmits the data inputted and accumulated to the upper layer. The input/output control program 1401 for Thin receives the output data for the Thin client 4 from the upper layer and stores it as the output data. The input/output control program 1401 further acquires layout (format) of the input screen to be outputted to the display 6a from the screen definition information 1403, synthesizes the output data, creates the input screen and transmits it to the Thin client 4. The screen definition information 403 contains the layout information of the input screen and transition information of the input screens and is stored in the hard disk 14. Incidentally, FIG. 5 shows an example of the input screen.

The input/output control program 1402 for Rich analyzes the input (transmission) data from the Rich client 5 and transmits it to the upper layer. The input/output control program 1402 for Rich receives the output data from the Rich client 5 from the upper layer, edits it for the Rich client 5 and transmits the data.

The upper layer has a flow-control program and flow definition information for calling and selecting the component customized for each transaction on the basis of the message received from the client and the host 2. When a sequence of a plurality of transactions corresponding to a certain transaction is defined by the flow definition information, the component used for this transaction is called and executed by the flow control program. In other words, it is not necessary to prepare in advance those components which are used in common in a plurality of transactions for each transaction. Also, customization becomes easier because the sequence of the transaction defined by the flow definition information can be changed, though the sequence of the transactions varies depending on the financial institution. Incidentally, since it has been customary to prepare definition describing the series of transactions for each certain transaction of a certain financial institution, a large number of overlapping occur and customization is not easy.

The components for executing the processing of the transaction manage not only the content of the transaction but also the data, and execute data edition/analysis by themselves. In consequence, independence can be kept among the components and re-combination for each component becomes easy. The data and the edition system by the component can be defined because they greatly change in many cases depending on the financial institution, the transactions and the businesses. When this system is employed, the customization cost for each financial institution or for each transaction can be reduced besides the use of the flow control function. Incidentally, this specification stipulates that the transactions contain the businesses and the businesses have the relation that contains the operations of the financial devices. However, there are those businesses which do not contain the operations of the financial devices and the transaction that is constituted by a single business.

The component group 1406 includes message analysis/distribution components, electronic journal components, user management components, bankbook control components, cash control components, cash/totalization management components, host transaction components, and so forth. The component group 1406 indicates a group of software but may contain hardware, too.

The message analysis/distribution component has transmission definition information, edits (translates) the data handed over thereto into the format of host data in accordance with the transmission definition information and transmits the data to the host 2 (calls the host transaction component). When receiving the return message from the host 2, the message analysis/distribution component analyzes the message and distributes it to a suitable component.

The user management component manages login/logout of the user, transmits the information to the user management server and checks the transaction authority permitted to the user.

The bankbook control component executes the processing inclusive of the operation of the bankbook printer 9 and also executes analysis of the data read from the magnetic stripe and edition of the output data.

The cash control component executes the processing inclusive of the operation of the cash dispenser 8.

The electronic journal control component edits input monitor printing data from the input data in accordance with the input monitor definition and executes input monitor printing. The electronic journal control component executes output printing for the reply message from the host (edits the data in accordance with the output definition information in the case of logical data). This component also provides a journal retrieval function. It is more effective to execute concentrated management by the server than the management by the client.

The cash/totalization management component executes cash management of the cash dispenser and the totalization management for each client and for each branch.

The host transaction component manages the serial number that is given whenever communication with the host 2 occurs as well as the status of the host 2.

A common base program 1405 of the upper layer is a base common to the automated teller machine (ATM) besides the client. The common base program 1405 has a construction management program for managing the constructions of the Thin client 4, the Rich client 5 and the financial devices (address, branch number, machine number, terminal construction) and status, a trace acquisition program for acquiring a trace (fault history, etc) in the AP server 1 and utilizing it for maintenance and inspection, a database access program for gaining access to the DB and a fault countermeasure program for collecting information of the host transaction component, the trace acquisition program, the cash control component and the bankbook control component when any fault occurs in the AP server 1 and controlling the alarm condition.

The common base program 1405 also has a common memory area 1408. The common memory area 1408 may exist in an internal memory of the processor 11 or in a semiconductor memory.

The device control server 3 includes a processor 31, an interface 33 and a hard disk 34. They may be regarded as being fundamentally the same as the aforementioned processor 11, interface 13 and hard disk 14, respectively, though the specifications, etc, are somewhat different as the hardware.

However, the interface 33, in particular, takes charge of the communication base for the AP server 1 and the sequence of the processing, receives a device instruction from the AP server 1, for example, calls WOSA/XFS-AP1 and reports the event of the device to the AP server 1. This interface 33 includes not only connectors as the hardware but also the software (called “device control middleware” or “device agent”).

The hard disk 34 stores a device service provider, a device driver 3402, a construction management program, and so forth.

The device controller 3402 controls the concrete operations of the devices. For example, the device driver 3402 generates the instructions for driving control of the motor for conveying the bank notes in the cash dispenser 8, opening/closing of the shutter of the cash dispensing port, the vertical and transverse movement of the printing head of the bankbook printer 9 and driving of the page turn-over roller.

The device service provider 3401 (device SP 3401) monitors the operation of the device and takes the fault countermeasure when the device does not operate normally, that is, at the time of fault. For example, the device service provider 3401 re-transmits the instruction signal.

The construction management program manages the status and occupation of each device.

Each of the Thin client 4 and the Rich client 5 has a processor 41, 51, an interface 43, 53 and a hard disk 44, 54. They may be regarded as being fundamentally the same as the aforementioned processor 11, interface 13 and hard disk 14, respectively, though the specifications, etc, are somewhat different as the hardware.

The description about the interface 33, the device SP 3401 and the device driver 3402 holds true as such of the interface 53, the device SP 5402 and the device driver 5401 of the Rich client 5. Generally, however, the device control server 3 has the driver and the service provider capable of coping with a greater number of devices than the Rich client 5.

The screen definition information 5403 is substantially the same as the screen definition information. However, the screen definition information 1403 has screen information that the Rich client 5 does not have. For example, the screen definition information 1403 has those screens which are utilized at so-called “high counters” such as foreign exchange transactions and loan consultation transactions.

The Thin client 4 basically has only a browser 4401. On the other hand, the Rich client 5 executes input check/edition, screen preparation, screen transition, etc, in accordance with the screen definition information 5403 in addition to the screen input/output on the Rich client 5. The Rich client 5 further accumulates the input data and the output data. It further receives the message from the server and individually displays the message or reports it to the client process that is registered in advance. The Rich client 5 receives the report when the device starts operating, too.

The Rich client 5 and the Thin client 4 are different from each other in that whereas the former has the device control function and the screen definition file, the latter does not have the device control function and the screen definition function. Concrete examples of the device control function are the device SP5402 and the device driver 5401.

The Thin client 4 may have a construction more economical than that of the Rich client 5 and has a high maintenance property because updating of the device driver 5401 and the device service provider 5402 can be made by updating the device control server 3. In the Thin client 4, on the other hand, the screen from the AP server is received through the communication line and the operation of the device is controlled and the control result is received by the display control server. Therefore, the response to the operation of the teller is affected more strongly by the communication line, the AP server and the device control server than the Rich client 5. For this reason, the Rich client 5 generally has faster response and higher operation factor than the Thin client 4.

Both Thin client 4 and Rich client 5 do not store the data in the client, but the servers accumulate and manage the journal and the totalization data and the AP server 1 executes all of the data edition/analysis and logical construction management. In this point, the Rich client 5 is different from Fat clients of the prior art.

When the device control server 3 is installed separately from the AP server 1 of the center at the branch or a place physically near the branch, the communication load with the financial devices can be reduced. The financial devices such as the cash dispenser and the bankbook printer have large communication information quantity and high line load because of their complicated operations (opening/closing of shutter, judgment of cash, conveying of cash and bankbook, read of magnetic stripe, turnover of pages, etc). On the other hand, stability and security are required because valuable media such as the cash and bankbooks are handled. Owing to this specific circumstance, the effect of reducing the communication load is extremely high.

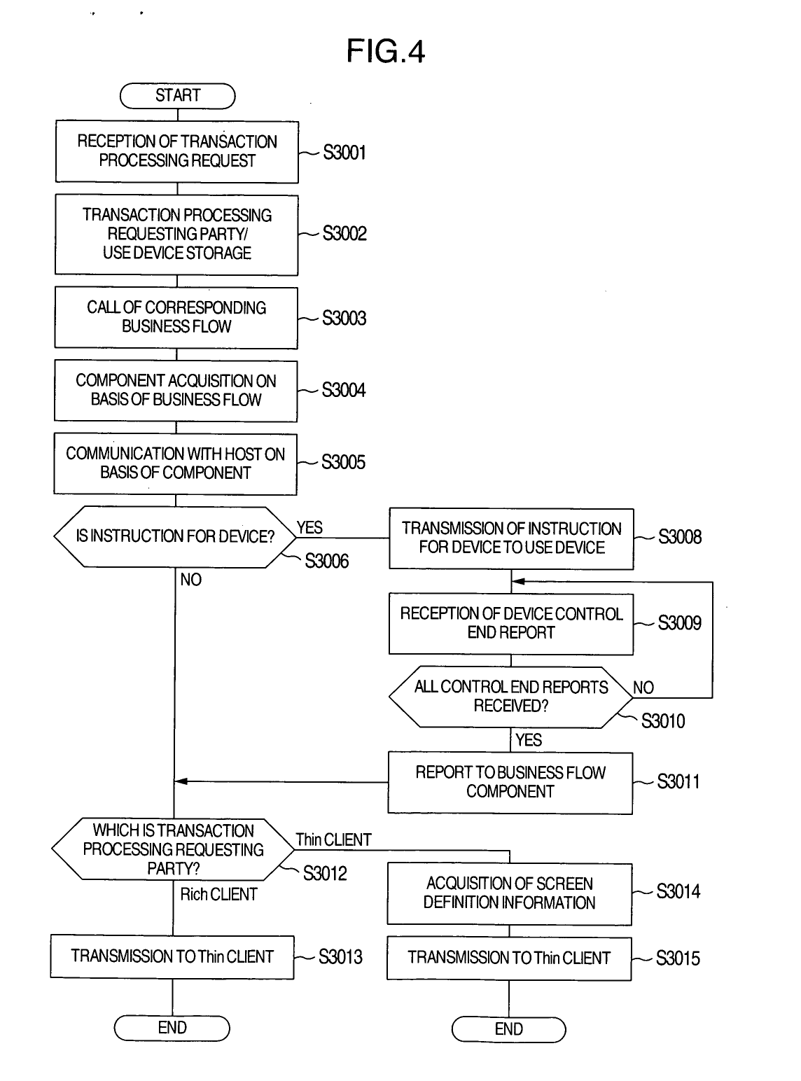

FIG. 4 shows a flowchart executed by the processor 11 of the AP server 1 by using various programs.

The Thin client 4 or the Rich client 5 inputs designation of the transactions (for example, deposit) and the request of the transactions inputted to the AP server 1 is transmitted through the interface 43 or 53 of the Thin client 4 or the Rich client 5. Designation of the transactions may be made by receiving the key input of the teller through the keyboard 7, etc, to designate the kind of the transactions, or by reading the image of the slip (for example, deposit slip) through the scanner, recognizing the mark/code/characters, etc, and automatically designating the kind of the transactions.

The AP server 1 (or its processor 11) receives the request of the transactions from the Thin client 4 or the Rich client 5 through the interface 13 (S3001).

The input/output control program 1401 for the Thin client or the input/output control program 1402 for the Rich client receives the request for the transactions from the Thin client 4 or the Rich client 5, specifies the transmission party of the transaction request and stores it into the common memory area 1408 (S3002). The transmission party can be specified by acquiring the transmission party from the header contained in the message containing the transaction request. The storage form may be “machine number 11111”, “network address”, “first client of A branch” and “first Thin client 4 of A branch”, for example. When the use device is designated in the client, the use device designated is stored in the common memory area, too. The storage form may be “bankbook printer No. 3” or “cash dispenser No. 2”, for example. Designation may be made by the operator as shown in later-appearing FIG. 5 or may be automatically designated by the client or the server.

The flow control program 1404 retrieves and acquires the business flow set for each transaction by using the code of the transaction in the flow definition information as a key in such a fashion as to correspond to the transaction request received by the lower layer and transmitted to the upper layer (S3003). In other words, the processor 11 acquires the business flow corresponding to the transaction request. In the case of the deposit transaction, for example, the business flow “report of transaction request to host→acceptance of money→counting→report of paid amount to host→entry to bankbook” is selected.

The flow control program 1404 selects the component on the basis of the business flow and gives an instruction (S3004). In other words, the flow control program 1404 acquires the corresponding component on the basis of the business flow acquired. The business flow is also called “flow corresponding to transactions” or “transaction flow”.

When the flow “report of transaction request to host→acceptance of money→counting→report of paid amount to host→entry to bankbook” is acquired, for example, the instruction is given to the host transaction management component as for the business of “report to host”, the instructions of “acceptance of money” and “counting” are given to the cash control component as for the business of “acceptance of money” and “counting” and the instruction of printing the bank book is given to the bankbook control component as for the business “entry to bankbook”.

The component group 1406 to which the instructions are thus given executes the respective transactions in accordance with the instructions. For example, the message analysis/distribution component analyzes the message acquired from the host 2 by the host transaction management component and when detecting that the message contains the instruction to the bankbook printer 9, the instruction to the screen and the instruction to the cash dispenser 8, the flow control program calls the bankbook control component. The bankbook control component transmits to the bankbook printer 9 the message containing the instruction to the lower inserter of the bankbook printer to the effect that printing (inclusive of page turnover) should be made and finished, for example.

Generally, the host transaction management component first reports the transaction request to the host 2 and then the message analysis/distribution component analyzes the reception from the host 2 and distributes the message containing the instructions to other components (S3005).

Whether or not the message so distributed contains the instruction to the devices is judged (S3006). The messages addressed to the devices are those which are distributed to the bankbook control component and the cash control component.

When the instruction to the devices is contained (Yes in S3006), the instruction is transmitted to the use device when such a use device designated is found existing by referring to the common memory area 1408 (S3008). For example, when the message containing the instruction of bankbook printing is distributed to the bankbook control component and when the bankbook printer No. 3 is designated as the use device, the instruction is transmitted to the bankbook printer No. 3. When the designated use device does not exist, the device is decided and transmitted in accordance with the condition set in advance. This predetermined condition may designate the device connected to the Rich client when the Rich client requests the transaction processing and the device that is close to the Thin client and is empty or the device having a younger number when the Thin client requests the transaction processing, for example. The transmission destination device is stored in the common memory area 1408. Incidentally, transmission of the instruction to a device includes transmission through the Rich client 5 or through the device control server 3 that manages that device.

When the processing is executed in the device to which the instruction is transmitted, control completion report is received (S3009). When the control end report is received from all the devices of the transmission destination stored in the common memory area 1408 (Yes in S3010), the report is made to this effect to the business flow component. Since the form such as multi-cast distribution is conceivable, it may also be possible to judge whether or not the control end report is received from a plurality of devices (cash dispenser and bankbook printer, for example) requiring the processing. Incidentally, if the control-end report is received whenever the processing of the device is executed, it becomes unnecessary to judge whether or not all the processing is complete in the devices, the device control server and the Rich client, and the cost can be reduced. It is further possible to judge whether or not the control is finished in all these devices and to return the result to the AP server 1.

In Step S3012, whether the transmitting party of the request for transaction received by the Thin/Rich client distribution program 1047 is the Thin client 4 or the Rich client 5 is judged from the storage of the common memory area 1408. When the storage of the memory has the form “machine No. 11111”, “network address” and “1^{st} client of A branch”, judgment cannot be made by merely referring to this storage. Therefore, whether the client of the machine number 1111/network address/first client of A branch corresponds to the Thin client 4 or to the Rich client 5 is judged by using the correspondence table stored in the hard disk 14.

When the transaction processing requesting party is the Thin client 4 (Thin client in S3012), the corresponding screen information is acquired from the screen definition information 1403 and the content of the message is pasted to the screen information for synthesis (S3014). This is because the screen definition information 1403 is not provided to the Thin client 4 as the transmission destination. The content of the message so synthesized and the screen information are transmitted to the Thin client 4 (S3015).

When the transaction processing requesting party is the Rich client 5 (Rich client in S3012), the content of the message is sent to the Rich client 5 without synthesizing with the screen information of the screen definition information 1403 (S3014). For, the Rich client 5 has the device control function and the screen definition information.

Since the AP server 1 has the function of judging the kind of the clients as described above, the portion for executing the transactions can be used in common and the Thin client 4 and the Rich client 5 can exist in parallel with each other.

Unlike the modified example that will be later described, the device control server 3 can be utilized from the Rich client 5, too, by judging the device to be transmitted independently of the kind of the client and/or prior to the decision of the kind. On the contrary, the devices connected to the Rich client 4 can be utilized from the Thin client 4, too. This means is effective under a specific condition where it is desired to utilize a large number of clients or when a part of the devices is in fault.

FIGS. 5A and 5B show an example of screen transition for designating the cash dispenser 8 and the bankbook printer 9 used by the teller of the Thin client 4.

The drawings show the device selection screen displaying the server management condition of the bankbook printer 9 or the cash dispenser 8 installed inside the branch at the time of transactions using the devices or when the device keys are pushed down. This condition is managed by the construction management program 3403 and this is the same as the management of the occupation condition.

The financial device selected by the teller on the device selection screen is kept under the occupation condition by the teller (or Thin client 4). An icon representing the number of the financial device occupied is displayed on the screen of the subsequent transactions. Incidentally, the financial device close to the Thin client 4 may be automatically allocated.

The guide number is inputted and the guide key having the screen retrieval function is pushed on the initial screen (G5001) to search the ordinary money acceptance screen as the transaction object screen.

When the bankbook printer key is pushed on the ordinary money acceptance screen (G5002), the bankbook printer selection screen (G5003) displaying the condition of the bankbook printer 9 arranged inside the branch is displayed. The construction management program 3403 inside the device control server 3 manages the device status of the bankbook printer 9. The Thin client 4 communicates with the device control server 3 through the AP server 1 and displays the bankbook printer selection screen (G5003) displaying the status of the bankbook printer 9. When the teller pushes a numeral+ten-key, the bankbook printer 9 is occupied by the teller. The bankbook printer (9) selection screen is erased on the Thin client (4) screen and the icon representing the number of the bankbook printer 9 occupied on the screen is displayed on the screen to report to the teller which bankbook printer 9 is occupied (G5004). When the teller sets the bankbook and the slip to the bankbook printer 9, the device control server 3 detects setting of the bankbook and the slip, and the bankbook set condition and the slip set condition are displayed on the Thin client (4) screen occupied, through the AP server 1. The magnetic stripe data is read by setting of the bankbook to the bankbook printer 9 and the data of the corresponding account number corresponding to the field definition on the transaction screen among the data so read is cut out and displayed on this field (G5005).

When the transaction amount is subsequently inputted, a balance screen (G5006) representing the balance is displayed to report the cash handling condition with respect to the transaction amount. When the cash dispenser key is pushed on the ordinary money acceptance screen (G5006), a cash dispense selection screen (G5007) representing the condition of the cash dispenser 8 installed inside the branch are displayed. The device status of the cash dispenser 8 is managed by the construction management program 3403 of the device control server 3. The Thin client 4 communicates with the device control server 3 through the AP server 1 and the cash dispenser selection screen (G5007) representing the status of the cash dispenser 8 is displayed. When the teller pushes the numeral+enter key, the corresponding cash dispenser 8 is brought into the occupation state by the teller. The cash dispenser selection screen is erased on the screen of the Thin client 4 and the icon representing the number of the cash dispenser 8 occupied on the screen is displayed and which cash dispenser 8 is occupied is displayed on the transaction screen of the Thin client 4 through the AP server 1 (G5008). When the teller sets the cash to the cash dispenser 8, the device control server 3 detects the acceptance condition and reports it to the occupying Thin client (G5010). When the teller pushes a money-kind screen key, the money-kind screen (G5010) for confirming the cash handling condition is displayed to reflect the acceptance condition of the cash dispenser 8. In this case, to generate the acceptance of ¥10,000 for the transaction amount of ¥9,000, the balance ¥1,000 must be paid to make ends meet. Therefore, a high order money-kind is assorted for ¥1,000 to be paid as the balance by the balance key and the automatic payment key to establish the condition for paying one ¥1,000 bank note from the cash dispenser 8 and to confirm that the balance between the transaction amount and the cash handling amount becomes ¥0 (G5011). When the money-kind screen key is pushed to display the ordinary acceptance screen (G5012), it becomes possible to confirm that the difference on the income/outgo balance screen is ¥0, too, and data entry as the ordinary acceptance can be completed.

Though the dedicated keys such as the bankbook printer key 9 and the cash dispenser key 8 are allocated to designate the use keys, they may be handled as a whole as the financial device keys so that all the use device keys can be displayed on one screen.

When transmission/reception to and from the host 2 is executed through the AP server 1 by pushing the finish key and the output message to the devices is received, the output content to the device occupied by the Thin client 4 is displayed as a device output instruction screen (G5013) and the output processing for the occupying device is serially executed from the AP server 1 through the device control server 3. The teller confirms the output instruction content to the cash dispenser 8 through the device output instruction screen, receives the balance outputted from the cash dispenser 8 occupied and then pushes the enter key to proceed to the next screen (G5014). The teller confirms the output instruction content to the bankbook printer 9 on the device output instruction screen, receives the bankbook and the slip from the bankbook printer 9 occupied, pushes the enter key to erase the device output instruction screen, detects the finish of one transaction and displays the initial screen (G5015).

The screen transition example shown in FIG. 5 represents the operation system in which the operation is executed while the instructions to the devices are reliably confirmed one by one. However, it is also possible to display at once all the instructions to the devices. In such a case, the walking distance of the teller can be minimized.

When the teller is allowed to select the device and to confirm one by one the output instructions to the devices by one operation, each teller can handle on his own judgment and responsibility the important media such as the bankbook and the cash. Needless to say, in the case of the input for each transaction or the transaction not involving the payment acceptance processing, the transaction can be executed without selecting the devices and the server side can judge the priority by allocation to the device closer to the Thin client 4.

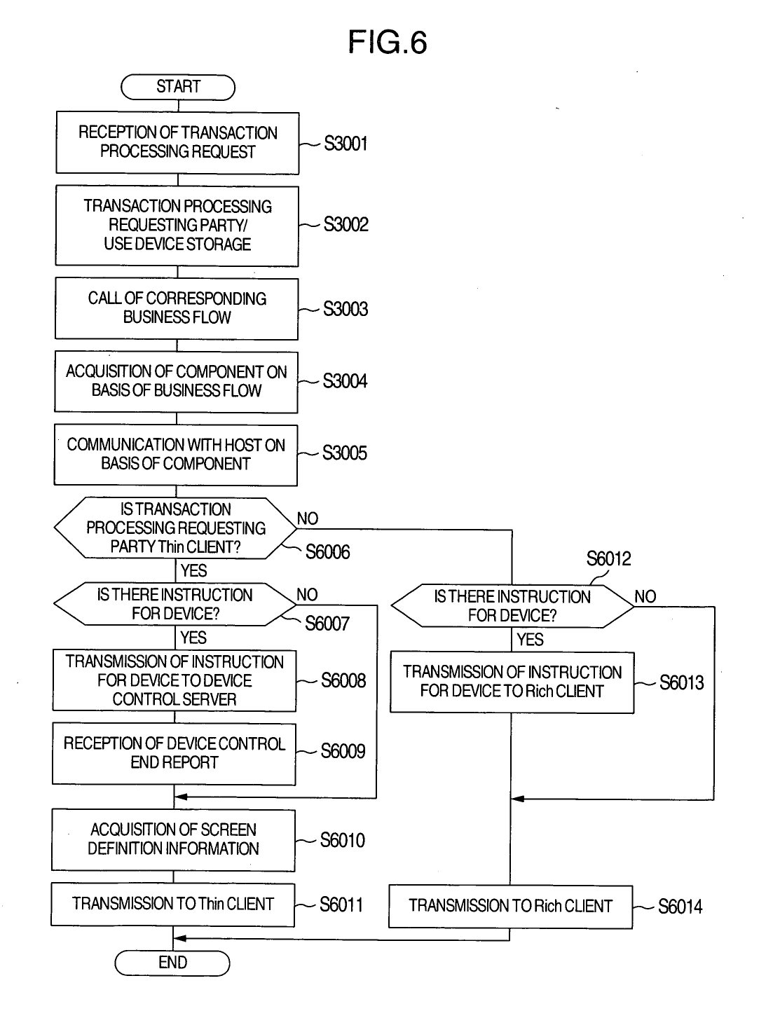

FIG. 6 shows a modified example of FIG. 4. In this modified example, the transaction processing requesting party is judged prior to transmission to the device. This modified example has the advantage that when the transaction processing is executed by using the device managed by the Rich client itself, the processing can be executed in the same way as in the prior art after the party is judged as the Rich client. The Steps S3001 to S3005 are common with FIG. 4. Therefore, Steps after S6006 will be explained.

When each component called in S3005 executes the business and the instruction and the report are transmitted outside the AP server 1, the Thin/Rich distribution program 1407 judges whether the transaction processing requesting party is the Thin client 4 or the Rich client 5 from the storage of the common memory area 1408 (S6006). When the storage of the memory is “machine No. 11111”, “network address” and “first client of A branch”, judgment cannot be made by referring to only this storage. Therefore, whether the first client of the machine number 1111/network address/first client of A branch corresponds to the Thin client 4 or to the Rich client 5 is judged by using the correspondence table stored in the hard disk 14.

When the transmitting party is the Thin client 4, whether or not the instruction to the device exists is judged (S6007). The instruction to the device is the instruction that involves the operation of the financial devices such as opening/closing of the shutter of the cash dispenser, conveying of the banknotes, acceptance of the bankbook and page turnover by the bankbook printer 9. In the case of the cash acceptance transaction, the bank notes are paid through the cash dispenser 8 and the bankbook printer 9 prints the amount accepted. Therefore, the message transmitted in each business of the component group 1406 contains the instruction addressed to the device. The transactions not containing the operations of the financial devices are balance reference transactions and loan consultation transactions, for example.

When the transaction requesting party is the Thin client 4 and the transaction contains device control, the instruction for the device is transmitted to the device control server 3 but not to the Thin client 4 (S6008). Because the Thin client 4 does not have the function of device control, the device control server 3 as the transmission destination is so scheduled as to correspond to the Thin client 4 as the requesting party and is, for example, the device control server 3 installed in the same branch as the Thin client 4 as the requesting party.

The device control server 3 transmits the instruction for practically operating the device on the basis of the instruction of the component. For example, when the message generated from the bankbook control component and instructing to print (inclusive of page turnover) and finish printing to the lower inserter is received through the interface 13, the head, etc, is actually operated by the driver for printing. The device SP3401 monitors the movement of the head, etc, takes the fault countermeasure such as re-transmission of the signal when detecting any abnormality of the operation and checks the normal finish. After checking the normal finish, the device SP3401 transmits the control end report from the device control server 3 to the AP server 1 through the interface 13.

The bankbook control component and the cash control component receive the operation end report of the financial devices from the device control server 3 (S6009). They exchange communication with the host 2 and further continue the business when the subsequent business in the business flow acquired by the flow control program 1404 is the report to the host.

When the message is transmitted to the Thin client 4, the corresponding screen information is acquired from the screen definition information 1403 and the content of the message is pasted to the screen information for synthesis (S6010). The content of the message so synthesized and the screen information are transmitted to the Thin client 4 (S6011).

When the transmitting party is the Rich client 5, the instruction to the device is sent to the Rich client 5 (S6013) and the message generated by the AP server 1 is sent to the Rich client 5 without synthesizing it with the screen definition information 1403 (S6014).

One embodiment of the invention has been described above. Incidentally, the object and effect of the invention can be accomplished in some cases by suitably selecting and modifying the construction of this embodiment and its function. For example, the object and effect brought forth by the conjoint use of the Rich client 5 and the Thin client 4 can be accomplished by integrally providing the function (program, etc) of the device control server 3 to the AP server 1. The object and effect for stabilizing the control of the financial devices can be accomplished by separating the device control server 3 from the AP server 1 and positioning it close to the Thin client 4 even when the Rich client 5 does not exist.

It should be further understood by those skilled in the art that although the foregoing description has been made on embodiments of the invention, the invention is not limited thereto and various changes and modifications may be made without departing from the spirit of the invention and the scope of the appended claims.

1. A server/client system comprising:
a plurality of terminals for inputting requests of transactions;
a first server for communicating with a host on a basis of the request of the transaction inputted by said terminal; and
a second server having a device control program for controlling devices on a basis of an instruction from said first server corresponding to the communication with said host.

2. A server/client system as defined in claim 1, wherein said plurality of terminals includes a first client having input screen information and a second client not having said input screen information, and said first server further has a program for judging whether an instruction is to said first client or to said second client when said instruction is transmitted to said terminal, and adding input screen information when said instruction is judged as an instruction to said second client.

3. A server/client system as defined in claim 1, wherein said plurality of terminals includes a first client having said device control program and a second client not having said device control program, and said first server further has an allocation program for transmitting to said first client an instruction to a device based on the transaction request inputted by said first client, and to said second server an instruction to a device based on the transaction request inputted by said second client.

4. A server/client as defined in claim 2, wherein said second client is connected to an image acquisition portion for acquiring an image of a slip through a line and further has a program for character-recognizing the image inputted by said image acquisition portion.

5. A server/client as defined in claim 1, wherein said terminal inputs an occupation request of at least one of a cash dispenser and a bankbook printer with the input of said transaction request, and when the occupation request is inputted by said terminal, said second server sets at least one of said cash dispenser and said bankbook printer to the occupation of said terminal and releases setting of the occupation when the transaction inputting the request with the occupation request is finished.

6. A server/client system comprising:
a first server having a flow control program for receiving a transaction request from a terminal, calling a flow of a corresponding transaction on a basis of said reception, calling a plurality of components and letting them conduct execution on a basis of the flow of said corresponding transaction; and
a second server having a device control program for controlling at least one of a cash dispenser for paying and receiving a cash and a bankbook printer for conveying a bankbook and printing the bankbook on a basis of an instruction of said first server corresponding to said reception.

7. A server/client system as defined in claim 6, wherein said first server is installed in a center connected to branches in which said terminals are disposed, through a communication line, and said second server is installed in said branch.

8. A server/client system as defined in claim 6, wherein said first server further has a program for judging whether said terminal is a first client having input screen information or a second client not having said input screen information when an instruction is transmitted from said flow control program to said terminal, and adds input screen information and transmit the information when said terminal is judged as said second client.

9. A server/client system as defined in claim 6, wherein said first server further has a program for judging whether said terminal is a first client having said device control program or a second client not having said device control program, transmitting an instruction to a device to said first client when said terminal is judged as said first client and transmitting the instruction to the device to said second server when said terminal is judged as said second client.

10. A branch system comprising:
a plurality of branch terminals installed in a branch of a financial institution, for inputting a transaction request;
a first server installed in a center connected to said branches through a line, for calling a flow of a corresponding transaction on a basis of the transaction request inputted by said branch terminal, calling a plurality of components and letting them to conduct execution on a basis of said flow of transaction; and
a second sever having a device control program for controlling at least one of a cash dispenser for paying and receiving a cash and a bankbook printer for conveying a bankbook and printing the bankbook on a basis of an instruction of said first server corresponding to said request at said branch terminal.

11. A server/client system as defined in claim 1, wherein said second server is installed in said branch.

12. A server/client system comprising:
a first client having input screen information;
a second client not having said input screen information; and
a first server having a program for judging whether an instruction is for said first client or for said second client, and adding said input screen information and transmitting said information when the instruction is judged as being for said second client.

13. A server/client system as defined in claim 12, wherein said first server is installed in a center connected to a branch in which at least one of said first and second clients is installed, through a communication line.

14. A server for judging whether a terminal is a first client having input screen information or a second client not having said input screen information when an instruction is transmitted to said terminal, and acquiring said input screen information from a file and transmitting said information when said terminal is judged as said second client.

15. A transaction processing method executed by a server connected to a first client having screen definition information and to a second client not having said screen definition information through a communication line, comprising the steps of:
receiving a request for a transaction processing from said first client or said second client;
storing a requesting party of said transaction processing;
transmitting an instruction corresponding to said request for said transaction processing received to a plurality of devices through the communication line; and
adding screen information, when a control end report is received from said plurality of devices receiving the information, and transmitting said information to said second client when the requesting party of said transaction processing stored is said second client.

16. A branch system comprising;
a second server having a device control program for controlling at least one of a cash dispenser for paying and receiving a cash and a bankbook printer for conveying a bankbook and printing the bankbook;
a first client having said device control program;
a second client not having said device control program; and
a first server for judging whether a client is said first client or said second client in a transaction utilizing at least one of the cash dispenser and the bankbook printer, transmitting an instruction for a device in said transaction to said first client when the client is judged as said first client and transmitting the instruction for the device in said transaction to said second server when the client is judged as said second client.

17. A branch system as defined in claim 16, wherein said second server, said first client and said second client are installed in a branch, and said first server is installed in a center connected to said branch through a communication line.

18. A transaction processing execution method executed by a server connected through a communication line to a first client having a device control program for controlling at least one of a cash dispenser for paying and receiving a cash and a bankbook printer for conveying a bankbook and printing the bankbook, and to a second client not having said device control program, comprising the steps of:
judging whether a destination is to said first client or to said second client when an instruction is transmitted;
transmitting the instruction for the device in said transaction to said first client when the destination is judged as said first client; and
transmitting the instruction for the device in said transaction to said second sever having said device control program through a communication line when the destination is judged as said second client.
